(19) United States
(12) Patent Application Publication
(10) Pub. No.: US 2014/0111685 A1
(43) Pub. Date: Apr. 24, 2014

(54) CAMERA MODULE WITH LENS HOLDER AND CONNECTING PLATE BOTH POSITIONED ON SAME SUBSTRATE

(71) Applicants: HONG FU JIN PRECISION INDUSTRY (Shenzhen) CO., LTD., (US); HON HAI PRECISION INDUSTRY CO., LTD., New Taipei (TW)

(72) Inventor: WEI CHEN, Shenzhen (CN)

(73) Assignees: HON HAI PRECISION INDUSTRY CO., LTD, New Taipei (TW); HONG FU JIN PRECISION INDUSTRY (Shenzhen) CO., LTD., Shenzhen (CN)

(21) Appl. No.: 13/727,595

(22) Filed: Dec. 27, 2012

(30) Foreign Application Priority Data
Oct. 23, 2012 (CN) 2012104050015

(51) Int. Cl. H04N 5/225; G03B 17/12

(52) U.S. Cl. CPC H04N 5/2251; G03B 17/12
USPC 348/374; 396/529

(57) ABSTRACT

A camera module includes a lens module and a connecting plate. The lens module includes a substrate and a lens holder. The substrate includes an upper surface. The upper surface includes a packaging area and a connecting area on the exterior of the packaging area. A number of first pads are positioned on the connecting area. The lens holder is positioned on the packaging area. A plurality of second pads is positioned on the connecting plate and corresponds to the first pads. The second pads of the connecting plate are electrically connected to the first pads of the substrate.

### BACKGROUND

1. Technical Field

The present disclosure relates to camera modules, and particularly, to a camera module with reduced height.

2. Description of Related Art

Camera modules generally include a lens module, a connecting plate, and a conductive film. The lens module is electrically connected to the connecting plate by the conductive film. However, the lens module and the conductive film are staked on the connecting plate, which increasing the height of the camera module.

Therefore, it is desirable to provide a camera module, which can overcome the limitations described.

### BRIEF DESCRIPTION OF THE DRAWINGS

FIG. 1 is an isometric view of a camera module in accordance with an exemplary embodiment.

FIG. 2 is an isometric, exploded, and schematic view of the camera module of FIG. 1.

FIG. 3 is similar to FIG. 1, but viewed from another angle.

### DETAILED DESCRIPTION

Embodiments of the disclosure will be described with reference to the drawings.

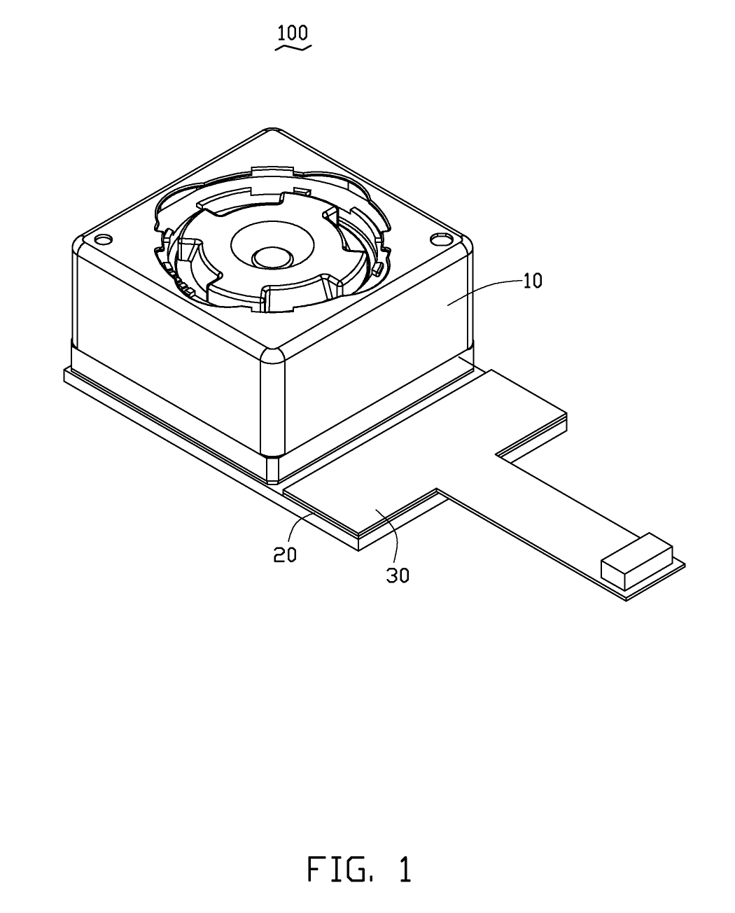

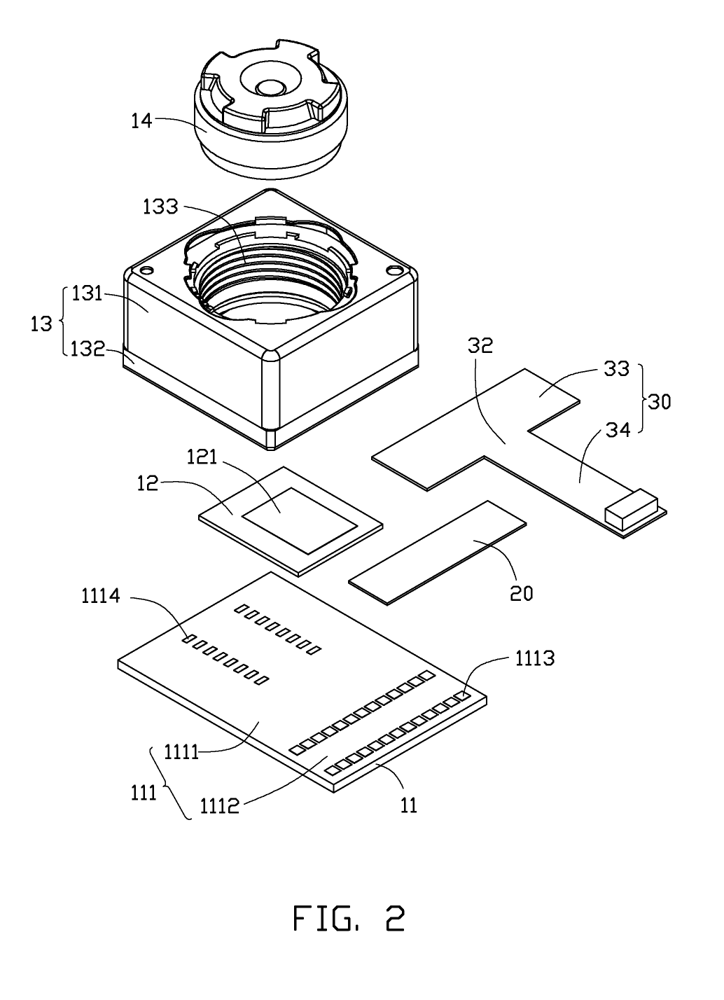

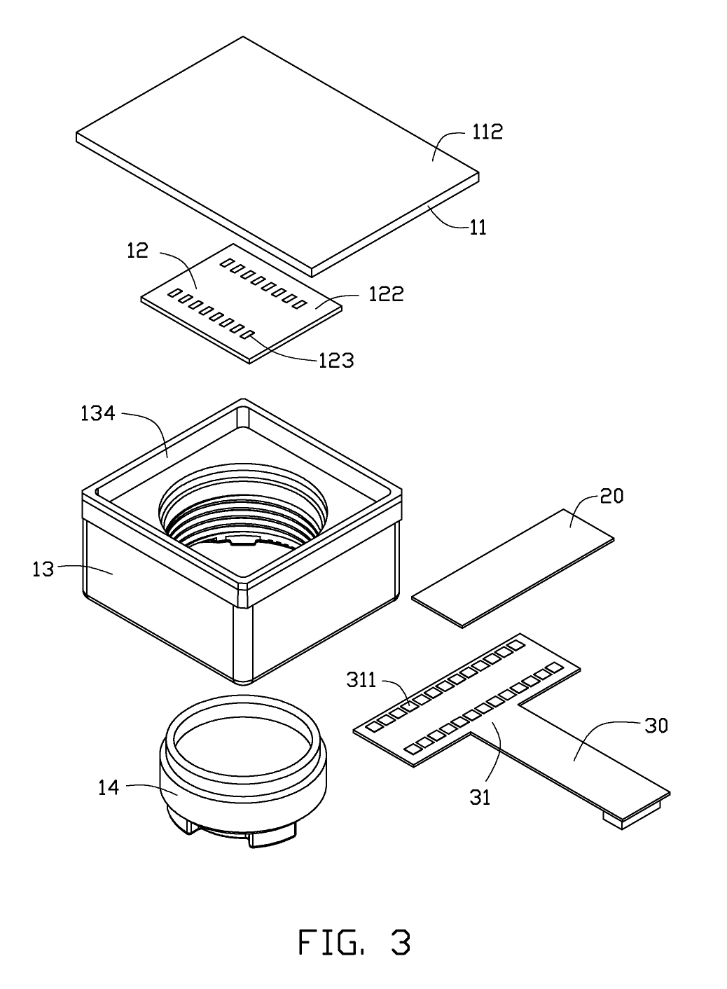

FIGS. 1-3 show a camera module 100 according to an exemplary embodiment. The camera module 100 includes a lens module 10, a conductive film 20, and a connecting plate 30.

The lens module 10 includes a substrate 11, an image sensor 12, a lens holder 13, and a lens barrel 14. The image sensor 12 and the lens holder 13 are positioned on the substrate 11. The lens barrel 14 is received in the lens holder 13.

The substrate 11 is plate shaped, and is a printed circuit board (PCB). The substrate 11 includes an upper surface 111 and a lower surface 112 opposite to the upper surface 111. The upper surface 111 includes a packaging area 1111 and a connecting area 1112 on the exterior of the packaging area 111. A number of connecting pads 1114 are positioned on the packaging area 1111, and a number of first pads 1113 are positioned on the connecting area 1112. In this embodiment, the connecting pads 1114 are arrayed in two rows parallel with an extending direction of the substrate 11, generally adjacent to two sides of the substrate 11. The first pads 113 are arrayed in two rows perpendicular to the extending direction of the substrate 11, and generally adjacent to one end of the substrate 11.

The image sensor 12 includes an image surface 121 and a bottom surface 122 opposite to the image surface 121. A number of pins 123 are positioned on the bottom surface 122. In this embodiment, the pins 123 are arrayed in two rows, generally adjacent to two edges of the bottom surface 122. The image sensor 12 is positioned on the packaging area 1111, and the pins 123 are electrically connected to the connecting pads 1114. The image sensor 12 is configured for converting light rays projected on the image surface 121 to image signals in form of electric signals, and the image signals are output from the pins 123. In the embodiment, the image sensor 12 can be a complementary metal-oxide-semiconductor transistor (CMOS) sensor or a charge coupled device (CCD) sensor.

The lens holder 13 includes a receiving portion 131 and a frame portion 132 positioned at one end of the receiving portion 131. The receiving portion 131 defines a receiving hole 133 penetrating two ends thereof. The frame portion 132 is frame shaped, and forms a receiving room 134 communicated with the receiving hole 133. The lens holder 13 is positioned on the packaging area 1111 of the substrate 10. The image sensor 12 is received in the receiving room 134, and the image surface 121 faces the receiving hole 133.

The lens barrel 13 includes at least one lens (not shown). The lens barrel 13 is received in the receiving hole 133 of the lens holder 13. The light rays penetrating the lens barrel 13 strikes on the image surface 121.

The conductive film 20 is an anisotropic conductive film, and is made of resin and conducting particles. In this embodiment, the shape of the conductive film 20 matches the shape of the connecting area 1112. The conductive film 20 is electrically connected along a direction perpendicular to the connecting area 1112 and is electrically disconnected along a direction parallel with the connecting area 1112 when the conductive film 20 is hot pressed.

The connecting plate 30 is a printed circuit board (PCB) or a flexible printed circuit board (FPCB). The connecting plate 30 includes a first surface 31 and a second surface 32 opposite to the first surface 31. A number of second pads 311 are positioned on the first surface 31, and generally adjacent to one end of the connecting plate 30. The second pads 311 are arrayed in two rows corresponding to the first pads 1113. At least one electronic element (not labeled) is positioned on the second surface 32. In this embodiment, the connecting plate 30 includes a connecting portion 33 and an extending portion 34 connected to the connecting portion 33. The second pads 311 are positioned on the connecting portion 33. The width of the connecting portion 33 is equal to that of the substrate 11. The width of the extending portion 34 is less than that of the connecting portion 33.

In the process of assembling the camera module 100, the conductive film 20 is adhered on the connecting area 1112, and then the connecting portion 33 of the connecting plate 30 is placed on the conductive film 20. The first pads 1113 are corresponding to the second pads 311. A pressing device (not shown) presses the connecting portion 33, the first pads 1113 are electrically connected to the second pads 311 along a direction perpendicular to the connecting area 1112.

In use, the image sensor 12 converts the light rays that have penetrated the lens barrel 14 to image signals. The image signals are output to the connecting plate 30 via the pins 123, the connecting pads 1444, the first pads 1113, and the second pads 311. As the lens holder 13 and the connecting plate 30 are connected to different areas of the substrate 11, the height of the camera module 100 is reduced.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A camera module, comprising:
a lens module, comprising:
a substrate comprising an upper surface, the upper surface comprising a packaging area and a connecting area on the exterior of the packaging area; the substrate comprising a plurality of first pads positioned on the connecting area; and
a lens holder positioned on the packaging area; and
a connecting plate comprising a plurality of second pads corresponding to the first pads, the second pads positioned on the connecting plate, the second pads of the connecting plate electrically connected to the first pads of the substrate.

2. The camera module of claim 1, further comprising a conductive film adhered between the first pads and the second pads.

3. The camera module of claim 2, wherein the conductive film is an anisotropic conductive film, and the conductive film is adhered on the connecting area.

4. The camera module of claim 1, wherein the substrate is a print circuit board, and the connecting plate is a flexible printed circuit board.

5. The camera module of claim 4, wherein the connecting plate comprises a connecting portion and an extending portion connected to the connecting portion, and the second pads are positioned the connecting portion.

6. The camera module of claim 5, wherein a width of the connecting portion along a direction perpendicular to an extension direction of the substrate is equal to a width of the substrate along the direction perpendicular to the extension direction of the substrate, a width of the extending portion along the direction perpendicular to the extension direction of the substrate is less than the width of the connecting portion.

7. A camera module, comprising:
a lens module, comprising:
a substrate comprising an upper surface, the upper surface comprising a packaging area and a connecting area on the exterior of the packaging area; the substrate comprising a plurality of first pads positioned on the connecting area; and
an image sensor electrically positioned on the packaging area;
a lens holder positioned on the packaging area and surrounding the image sensor; and
a lens barrel received in the lens holder; and
a connecting plate comprising a plurality of second pads corresponding to the first pads, the second pads positioned on the connecting plate, the second pads of the connecting plate electrically connected to the first pads of the substrate.

8. The camera module of claim 7, wherein the image sensor comprises an image surface and a bottom surface opposite to the image surface.

9. The camera module of claim 8, wherein the image sensor comprises a plurality of pins positioned on the bottom surface, the substrate comprises a plurality of connecting pads corresponding to the pins and positioned on the packaging area, the connecting pads are electrically connected to the pins.

10. The camera module of claim 7, wherein the lens holder comprises a receiving portion and a frame portion positioned at one end of the receiving portion, the receiving portion defines a receiving hole receiving the lens barrel therein, the image sensor is received in the frame portion.
